(19) United States
(12) Patent Application Publication
(10) Pub. No.: US 2004/0216070 A1
(43) Pub. Date: Oct. 28, 2004

(54) Tools for automatic population of databases

(76) Inventor: Michael A. P. Smith, Tavistock (GB)

Correspondence Address: SCHNECK & SCHNECK, P.O. BOX 2-E, SAN JOSE, CA, 95109-0005, US

(21) Appl. No.: 10/831,246

(22) Filed: Apr. 23, 2004

(30) Foreign Application Priority Data
Apr. 25, 2003 (GB) 0309528.8

(51) Int. Cl. G06F 17/50; G06F 7/00

(52) U.S. Cl. 716/11; 707/102

(57) ABSTRACT

A method for automatically populating a database, comprises, creating an initial database comprising a first dataset; creating a rules database for operating on the first dataset to define new related data; and using the rules database to generate new related data so as to create an expanded database comprising a second dataset derived from the first dataset and the generated new data. The method can be implemented as a software product.

### FIELD OF THE INVENTION

This invention relates to tools for capturing and handling data that is stored in large and complex databases. Such databases are used in the design of complex systems, for example embedded semiconductor systems, system-on-chip, and the like.

### BACKGROUND OF THE INVENTION

Electronic designs can be thought of as having multiple views. Often these multiple views may contain different versions of the same information. For example, a system-on-chip will have hardware views. These hardware views will contain a representation of the system memory map built in to them in some way. Similarly, software views will also contain a representation of the system memory map built in to them. In addition, documentation such as data sheets that describe the system may also contain a full description of the memory map. This means that an electronic design typically has many different representations of the same data held in different places, and in different formats. This creates an environment that can potentially lead to inconsistency between different design views. The fact that often design teams working independently from each other usually develop these different views further augments the possibility of inconsistency.

In order to mitigate against the problems introduced by having multiple copies of data that can become inconsistent, the data can be stored in one or more structured databases in order that the data can be easily extracted and used. Design views can then be automatically generated from one single description thus eliminating the possibilities of inconsistency between views. This requires the common information to be stored in a structured way that is suited to generating all of the required design views.

A relational database can suit these requirements and provides a good method for storing and retrieving the data required to generate views with common information. The entries in a relational database not only indicate basic data values, but also indicate the relationships between the data entries. One format used to persist these databases is XML (extensible mark-up language), which allows data and data relationships to be encapsulated in an extensible, non-proprietary and platform-independent way.

A particular design view can only be automatically generated from a design database if the database contains enough information to generate that view. This implies that the more information that can be captured about an electronic system, the more design views can be automatically generated. However, the more information that is captured, the longer it can take designers to enter data into the design database. Ultimately, this could mean that it takes more effort to enter information into a design database to allow automatic design view generation than to manually create the design views.

The object of this invention is to provide a method that assists in the task of entering data into the design database, allowing designers to capture more detail of an electronic design in a design database. This would give the possibility of being able to automatically generate more design views, without the disadvantages of having to spend extra effort entering data into the design database.

### SUMMARY OF THE INVENTION

This invention provides a method for automatically populating a database, comprising: creating an initial database comprising a first dataset; creating a rules database for operating on the first dataset to define new related data; and using the rules database to generate new related data so as to create an expanded database comprising a second dataset derived from the first dataset and the generated new data.

The data preferably comprise electronic design data for semiconductor systems, such as data related to the interconnections between communication ports in different IP blocks of a system-on-chip electronic design.

The invention also comprises software for implementing the method on a computer, comprising an initial database for storing a first dataset; a rules database for storing rules for operating on the first dataset to define new related data; and an expander that uses the rules from the rules database to generate new related data and to create an expanded database using the first dataset and the generated new related data.

The step of creating an initial database typically comprises entering electronic design data into a relational database; and the step of creating a rules database comprises creating a database of rules relating initial elements of electronic design for a given system.

The rules can specify further design elements required to relate the initial design elements in a completed system.

One aspect of the invention comprises creating an abstract definition of parts of the system and using the abstract definition and the rules to specify the further design elements.

This invention preferably includes a method for specifying some parts of a design in an abstracted way. This abstract description can describe the extra information required for a specific implementation of a design.

This invention also preferably includes producing a set of implementation rules from the abstract description of the extra information. These implementation rules can then be represented in a machine-readable database structure.

Given that the rules can be made available electronically, it is now possible to provide a database application that uses the implementation rules to automatically generate the detailed information from the abstract description.

This invention can provide a database expander that uses the implementation rules to automatically populate a database with the objects, relationships and new components required to implement the information that has been specified in an abstract way.

The preferred database expander takes an existing design database (design database) as its input. This database expander uses the implementation rules to automatically generate instances of objects within the database. The database expander then produces a second database (expanded database) containing extra information particular to the implementation enforced by the rules. The way in which the new database objects are created is determined by the implementation rules operating on the contents of the design database.

For example, a database holding a system-on-chip design may need to capture the interconnections between the communication ports on different IP blocks. Implementation rules can be specified detailing how a bus system may be connected together. The rules describe how different components may be required depending on the contents of the original system-on-chip database. For example, a new decoder block and new read-multiplexer block must be created in the extended database if more than one target IP block (slave block) is connected to a bus. This allows designers to specify complicated bus connections in an abstract manner. The database expander takes the design database, applies the implementation rules and then automatically creates an expanded database containing the object instances; actual connections etc. that implement the bus connections.

In this invention, the rules for a design implementation need only be defined once. The implementation rules can be used over multiple projects. Using the bus interconnection example above, the rules for a given bus standard could be defined once and then used to implement bus connections on many different system-on-chip designs. This saves significant designer effort because it is not necessary to specify the implementation detail of each bus connection.

### BRIEF DESCRIPTION OF THE DRAWINGS

The various aspects of the present invention are described below in relation to the accompanying drawings, in which:

FIG. 1 shows an overview of automatic database population system;

FIG. 2 shows a schema diagram of the implementation rules database;

FIG. 3 shows an example design database;

FIG. 4 shows an example of inferred components;

FIG. 5 shows an example of an expanded database;

A terminology guide is included at the end of the description to aid in understanding.

### DETAILED DESCRIPTION OF THE PREFERRED EMBODIMENT

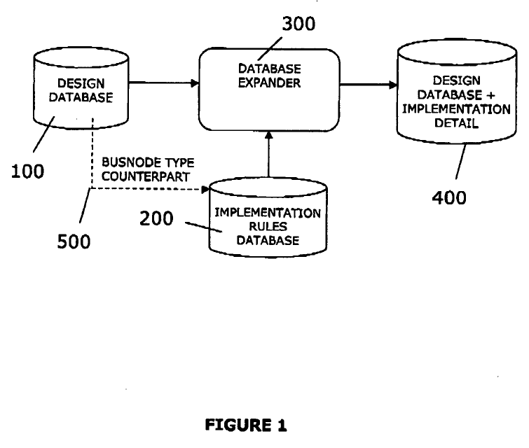

The system shown in FIG. 1 is a system for automatically populating a database with extra information. Such a system is typically implemented in software on a suitably programmed computer, either as a stand-alone application or implemented in a server-client environment. The system shown in FIG. 1 broadly comprises four main sections: a design database file 100, an implementation rules database 200, a database expander 300, and an expanded design database with extra information 400. Each is described further below.

A database is a document, file or collection of files storing a set of data in a structured way in conformance with a defined plan known as a schema, which describes the database design in terms of objects having one or more attributes. In this particular case, the database is a relational database: the relationships between the data are also stored, the object having extra fields to hold references to other object instances. The database file 100 is an electronic file, in this case in XML format, containing the object instances. The database file also contains a reference to a schema file that fully describes the types of object that the database file contains. The particular way in which electronic schema files are used by database tools is described in International Patent Application No. PCT/GB2004/001086 (incorporated herein by reference).

The database comprising the database file 100 in the present example is a system database storing systems, components, buses, nets, etc. The system database contains instances of IP blocks defined in a separate IP block database storing IP blocks, registers, bitfields, etc.

The database can be implemented programmatically in computer memory in the form of an architecture, which primarily maps the database concepts of object, attribute, and relationship into programmatic constructs. The architecture allows instances of objects described by the schema to be created, modified, deleted and related to other schema objects. The architecture is configured by reading a schema file and populated by reading the design database file 100.

In the current example, the design database contains a description of a system-on-chip. The communication between blocks in the system-on-chip can be specified in terms of connections between communication ports on each IP block. Each IP block can either have an Initiator Port or a Target Port: An Initiator Port initiates a data transfer; A Target Port responds to a data transfer from an Initiator. The desired connections could be specified entirely in terms of connections between these ports and the bus. However, this is not enough information to be able to automatically generate a hardware view of the port connections.

Implementation rules can be specified detailing how a bus system may be connected together. Examples of these rules are: an address decoder is created for a system if the system stored in the design database has more than one Target Port connected to a Bus; a read-data multiplexer is created for a system if the system stored in the design database has more than one Target Port connected to a Bus; all clock signals in a system must be connected to the master clock signal. The rules can go on to define which physical wires must be created to connect each Target Port to the new components. These rules can be based on a specific bus standard such as OCP or AMBA AHB Lite.

Once a set of rules have been produced, it is necessary to make the rules available programmatically by creating a database to store these rules.

By analyzing an abstract description of the rules, a database schema can be produced to describe the implementation rules database. This implementation rules database will describe how objects from the design database infer new objects particular to the implementation. In other words, the implementation schema can be used to hold all of the information necessary to infer and generate all components and connections required to implement the connections specified in a design database.

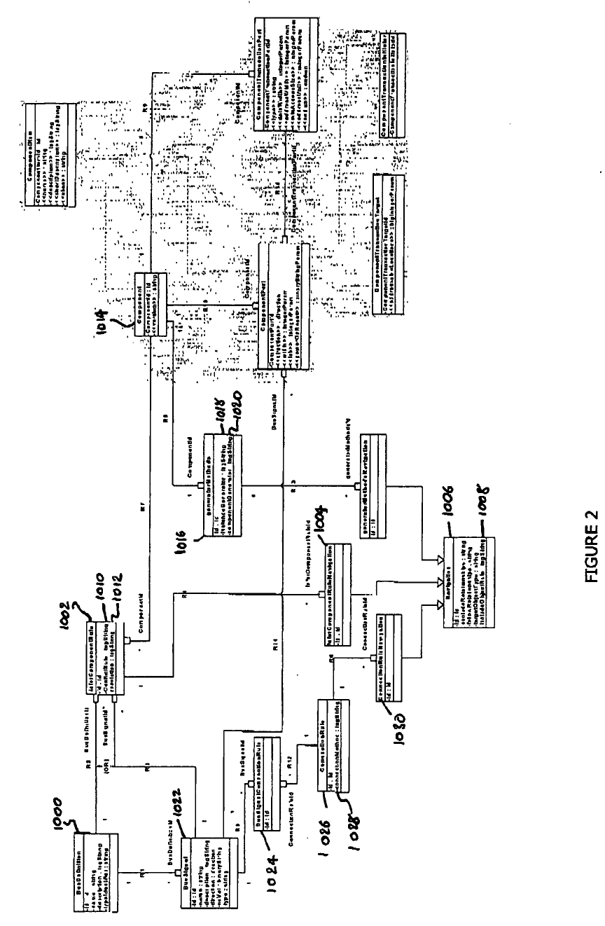

In the present example, FIG. 2 shows an example implementation schema capable of storing the information required to automatically populate a design database with a bus interconnection block.

The implementation rules schema, whose data relates to the interconnections between communication ports in different IP blocks of a system-on-chip electronic design, can be automatically translated into an electronic XML format by following a fixed process (such as described in international Patent Application No. PCT/GB2004/001086). Once a schema is made available programmatically, tools, generators and applications can be written.

The implementation rules database, hereafter referred to as the IRD 200, may contain multiple BusDefinition objects 1000. This BusDefinition object 1000 is the top-level object for describing particular types of system bus connections.

The design database 100 must be linked to a particular set of implementation rules. In the current example,a BusNode object in the design database 100 must reference the implementation rules database 200 containing the rules for that particular bus type.

The design database may be edited graphically using a Graphical User Interface. This GUI provides the ability to link an implementation rules database 200 to a design database 100. The BusNode object in the database contains an attribute called Type. This attribute identifies the type of system bus. The user is provided with a graphical tool for importing a BusDefinition 1000 (from a set of implementation rules database files) into the design database 100. The design database 100 now contains a link 500 (a counterpart) to the BusDefinition 1000 in the rules implementation database 200.

The database expander 300 takes the design database 100 as its input. The design database 100, representing an embedded system, is firstly implemented programmatically in computer memory. This architecture is configured by reading a schema file and populated by reading the design database file 100. The database expander can generate object classes, individual objects, and object characteristics for those individual objects(or attributes) and form relationships. Advantageously, because this architecture is generated from a representation of the schema of the design database to be read, the database expander is effectively independent of the database schema. In other words, a particular database expander can be used to extend any type of database as long as a schema file is available.

The database expander 300 comprises a generic application interface (API) that provides a navigation function for extracting data from the design database 100. The navigation function is described in international Patent Application No. PCT/GB2004/001086.

The database expander 300 iterates over objects in the design database 100. The database expander 300 only iterates over objects in the design database 100 that it is capable of expanding.

In the current example, the database expander 300 iterates over all of the BusNode objects in the current system in the design database 100. For each BusNode it follows the link and loads the corresponding implementation rules database 200.

The database expander 300 comprises a generic application interface (API) that provides Object Creation methods to automatically create associative/parent objects as required, and Object Deletion object functions to automatically delete associative/child objects as required.

The code described below works with the Object Creation methods available in the API to create an instance of each inferred component. The database expander then generates all of the required components and connections in three stages:

Stage 1—Infer Bus Fabric Components

The first stage of the component generation process is designed to infer the bus fabric components (for example, arbiters, decoders and bridges) that a bus standard dictates depending on the number of connections to the bus. When these components are instanced in the new expanded database, they will be marked as related only to the bus type.

The BusNode object in the design database 100 links to the required IRD 200 for that type. The database expander 300 loads the IRD 200 in memory.

The database expander 300 iterates over each of the InferComponentRule objects 1002 in the IRD 200 that are related to the BusDefinition object 1000 by relationship R2. Each InferComponent rule 1002 may be related to many InferComponentRuleNavigation objects 1004. The navigation objects specify a collection of objects in the design database 100.

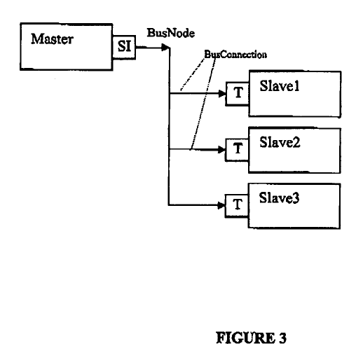

The IRD 200 can, for example, describe a particular bus Connection implementation. In this case, the rules may specify that the number of transaction targets and transaction initiators connected to a bus in the design database govern how the physical bus connection signals should be created. In FIG. 3, using the InferComponentRuleNavigation objects 1004 in the IRD 200, the database expander 300 iterates over each of the database objects inside the design database that specify bus connections between the Master IP block and the Slave IP blocks. The navigation starts from the BusNode object.

The database expander 300 performs each navigation and the resulting list of collections is compiled into a context list. Note that the Navigation object 1006 also has an includeObjectRule attribute 1008. This contains executable code that is run on every object collected. A returned true will insert the object into the compiled collection, a false will leave it out. If this attribute contains a null value all objects will be included by default.

In FIG. 3, an example system shows a Master connected to three slave IP blocks (Slave1, Slave2, Slave3) via a System Initiator SI and a BusNode. Each slave is represented in the database and has an IP Block Target object T. A Bus Connection object connects the Master to a slave's target T. The navigation methods within the database expander iterate over each of these bus connection objects. The navigation methods would return a list containing three IP Block Targets objects and one System Initiator object.

Each InferComponentRule object 1002 has a ConflictRule attribute 1010. This contains executable code that uses the context list passed into it to decide if it is necessary to infer a component in the expanded database. The InferComponentRule object 1002 also has a resolution attribute 1012. This contains code that is executed if the ConflictRule 1010 returns true. The same context list is passed into the resolution code as was passed to the ConflictRule code. The resolution method can be used to infer the components 1014 referenced by R7 from the InferComponentRule object 1002.

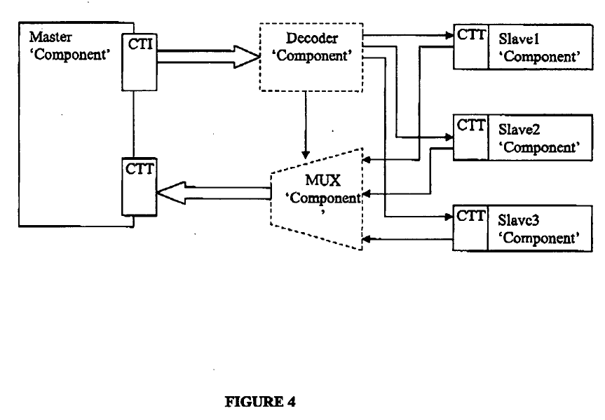

FIG. 3 shows a simple system represented in a design database. FIG. 4 shows an interconnection model for the simple system in FIG. 3 and how it could be represented in the new expanded database. The ‘Master’ and ‘Slave’ components and necessary transaction ports (ComponentTransactionInitiator CTI; ComponentTransactionTarget CTT) are created as described by the process in Stage 1 above. As part of this stage, the IRD may infer an address decoder component (FIG. 4: Decoder) because multiple slaves are connected to the master's bus.Bus fabric components 1014 that are automatically instanced by the InferComponentRule objects 1002 are themselves described in standard design databases (not shown). The component objects in the IRD 200 are counterparted to these objects in the standard design database description of the bus fabric components. When the bus fabric components are instanced in the design database they are also counterparted to the same design database descriptions of the bus fabric components. The IRD allows component ports to be associated with BusSignals. This information can be used to mark generated port instances with the appropriate Bus Signal name. This is then used later in the final stage 3 when all signals are connected up.

In addition to standard components, the IRD also provides for components that may be configured to the correct size for the BusNode being implemented.

A generatorMethods object 1016 may be associated with a bus fabric component 1014. It has two attributes. One supplies the executable code that may be used to generate the component instance. Another attribute supplies the executable code to configure the component itself. The generatorMethods object 1016 may also use Navigation objects 1006 to specify what is in the context list passed to the instanceGenerator code 1018 and the componentGenerator code 1020. These attributes may have null entries in which case the database will not try to execute any code.

Stage 2—Infer Signal-Specific Bus Fabric Components

The second pass is designed to infer components that a bus will require to connect specific signals. For example, read multiplexers or write multiplexers. These are new objects that were not captured in the original design database.

These components will depend on the number of connections to the bus in the design database. When they are inferred, they will be marked as related to the bus and the specific signal for which they have been generated.

As part of Stage 2, the IRD may infer a read-mux component (FIG. 4: MUX). For example, the InferComponentRule object may contain instructions to create a new Component object (called ‘Decoder’) when it finds a particular BusSignal.

Stage 3—Infer Signal Connections

The final stage goes through all of the generated and ordinary components connected to the bus and then connects all of their ports together.

The database expander achieves this by iterating again over each of the BusSignal objects 1022. There must be one BusSignal object 1022 defined for every signal that can form part of the bus (even if it is optional). Each bus signal can have a BusSignalConnectRule 1024 associated with it. Note that the same connection rule may be used for different bus signals. Each bus signal may have more than one connection rule. All connection rules are processed for each bus signal.

A connectionRule 1026 has one attribute, the connectionMethod 1028. This attribute contains executable code that performs the actual connection. As with other executable code segments, the context list passed into the code is specified using a Navigation object 1030.

When all of the connectionRules have been executed for all bus signals, the expanded database should contain the new interconnect information generated by the database expander as specified in the original design database.

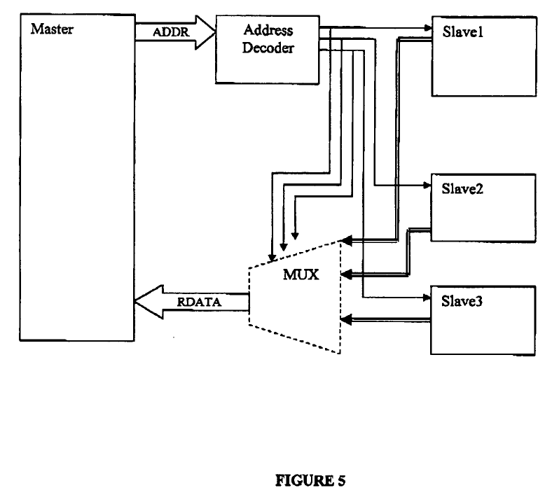

Taking the examples shown in FIG. 3 and FIG. 4, FIG. 5 shows a simple wiring diagram describing the actual physical signals that are generated by the database expander.

Example Implementation Rules Database

An example of an implementation rules database created in accordance with this invention and used to generate interconnect information for a bus system using the ARM AMBA AHB specification is presented below. The invention is not limited to this standard but can apply to any specification according to the desired design, The bus signals used in this implementation example (HADDR, HSIZE etc.) are specific to the AHB specification. This example relating to a bus interconnection model 15 only one embodiment of the invention and the general methods described can equally be applied to any type of database.

The contents of the design database determine whether the expanded database should contain a bridge, decoder and arbiter.

Stage 1—Infer Bus Fabric Components

A BusDefinition object called Ahb is created in the IRD database.

An InferComponentRule object 1002 called AhbBusComponent is created in the IRD. This object is associated with the Ahb BusDefinition.

Bridges for System Targets

A Component object 1014 called AhbBridge is associated with the AhbBusComponent InferComponentRule 1002.

The Navigation object 1006 for this AhbBusComponent InferComponentRule specifies a collection of every system target connected to the bus being implemented.

The ConflictRule 1010 returns true if there are one or more system target objects in the context.

The Resolution method 1012 instances an AHB Bridge component 1014 for each system target in the instance list. The instance names for the component and ports of each inferred bridge contain the system target name from the design database. The resolution method 1012 also creates System Ports for each signal that forms the Transaction Target port on the AHB Bridge and connects them to the corresponding port on the inferred bridge component.

Each port associated with a bus signal also has a connection node generated and connected to it. The connection nodes are marked with the bus signal name and contain the system target name in their name.

Bridges for System Initiators

A Component object 1014 called AhbBridge is associated with the AhbBusComponent InferComponentRule 1002.

The Navigation object 1006 specifies a collection of every system initiator connected to the bus being implemented.

The ConflictRule 1010 returns true if there are one or more system initiator objects in the context,

The Resolution method 1012 instances an AHB Bridge component for each system initiator in the instance list, The instance names for the component and ports of each inferred bridge contain the system initiator name from the design database. The resolution method 1012 also creates System Ports for each signal that forms the Transaction Initiator port on the AHB Bridge and connects them to the corresponding port on the inferred bridge component. Each port associated with a bus signal also has a connection node generated and connected to it. The connection nodes are marked with the bus signal name and contain the system initiator name in their name.

Arbiters

A component object 1014 called AhBArbiter is associated with the AhbBusComponents InferComponentRule 1002.

The Navigation object 1006 specifies a collection of each master connected to the bus (system transaction targets or located component transaction initiators).

The ConflictRule 1010 always returns true.

The AhBArbiter component 1014 has a generatorMethods 1016 object associated with it.

The resolution method 1012 instances one AHB arbiter component by executing the code in the instanceGenerator attribute 1018 on the generatorMethods object 1016. The instanceGenerator code 1018 modifies the generated instance so that the following ports are generated for each master connected to the bus:

HGRANT port related to the master component

HBUSREQ port related to the master component

HLOCK port related to the master component

HMASTER port related to the master component

HMASTERD port related to the master component

Note that all signals have associated connection nodes inferred that are specialized with the master name that they are being generated for. All Connection nodes are marked with the associated bus signal name and are named after the master they were generated for, or the bus name.

Decoders

A Component object 1014 called AhBDecoder is associated with the AhbBusComponents InferComponentRule 1002.

The Navigation object 1006 specifies a collection of each slave connected to the bus (system transaction initiator or located component transaction targets).

The ConflictRule 1010 always returns true.

The AhbDecoder component 1014 has a generatorMethods object 1016 associated with it.

The resolution method 1012 instances one AHB Decoder component by executing the code in the instanceGenerator attribute 1018 on the generatorMethods object 1016. The instanceGenerator code 1018 modifies the generated instance so that the following ports are generated for each slave connected to the bus:

HSEL Port Related to the Slave Component

Note that all signals have associated connection nodes inferred that are specialized with the slave name that they are being generated for. All connection nodes are marked with the associated bus signal name and are named after the slave they were generated for, or the bus name.

Stage 2—Infer Signal-Specific Bus Fabric Components

An InferComponentRule object 1002 called AhbBusSignalComponent is created.

Write Multiplexers

A Component object 1014 called AhBWMux is associated with the AhbBusSignalComponent InferComponentRule 1002.

The Navigation object 1006 specifies a collection of each master connected to the bus (system transaction targets or located component transaction initiators).

The ConflictRule 1010 always returns true.

The AhBWMux component 1014 has a generatorMethods object 1016 associated with it.

The resolution method 1012 instances one AHB write mux component by executing the code in the instanceGenerator attribute 1018 on the generatorMethods object 1016. The instanceGenerator code modifies the generated instance so that the following ports are generated for each master connected to the bus:

HMASTER port related to the master component

HMASTERD port related to the master component

HTRANS port related to the master component

HADDR port related to the master component

HWRITE port related to the master component

HSIZE port related to the master component

HBURST port related to the master component

HPROT port related to the master component

HWDATA port related to the master component

Note that all signals have associated connection nodes inferred that are specialized with the master name that they are being generated for. All connection nodes are marked with the associated bus signal name and are named after the master they were generated for, or the bus name.

Read Multiplexers

A Component object 1014 called AhBRMux is associated with the AhbBusSignalComponent InferComponentRule 1002.

The Navigation object 1006 specifies a collection of each slave connected to the bus (system transaction initiator or located component transaction targets).

The ConflictRule 1010 always returns true.

The AhBRMux component has a generatorMethods object 1016 associated with it.

The resolution method 1012 instances one AHB Read mux component by executing the code in the instanceGenerator attribute 1018 on the generatorMethods object 1016. The instanceGenerator code 1018 modifies the generated instance so that the following ports are generated for each slave connected to the bus;

HSEL port related to the slave component

HRDATA port related to the slave component

HREADY port related to the slave component

HRESP port related to the slave component

Note that all signals have associated connection nodes inferred that are specialized with the slave name that they are being generated for. All connection nodes are marked with the associated bus signal name and are named after the slave they were generated for, or the bus name.

Stage 3—Infer Signal Connections

A different BusSignal object is created for each bus signal, e.g. HLOCK; HMASTER; HMASTERD; HTRANS. These objects are associated with the Ahb BusDefinition object 1000, These objects are associated with the AhbBusSignalComponent InferComponentRule 1002.

Common Connect Rule

A ConnectionRule object 1026 called CommonConnect is created and is used to connect all signals such as reset and clock that are connected together regardless of their source.

The following BusSignal objects1022 use this rule: HCLK; HRESETn.

The Navigation object 1006 specifies a collection of all connection nodes associated with the current signal name.

The connectionMethod 1028 removes all but one of the existing connection nodes and connects all associated ports to the same connection node.

Per Master Individual Connect Rule

A ConnectionRule object 1026 called PerMaster is created and used to connect all signals that are point-to-point connections between two components specific to a master. For example, each master will have one HBUSREQ_<masterName>signal. The arbiter component will have one HBUSREQ_<masterName>signal for each master connected to the bus. This connection rule connects the master specific ports together separately.

The following BusSignal objects 1022 use this rule; HGRANT; HADDR; HBUSREQ; HLOCK; HMASTER; HMASTERD; HTRANS; HWRITE; HSIZE; HBURST; HPROT; HWDATA.

The Navigation object 1006 specifies a collection of all connection nodes associated with the current signal name and a master name.

The connectionMethod 1028 sorts all connection nodes so that they are grouped by master name. Each group of connections are connected together using one common connection node.

Per Slave Individual Connect Rule

A ConnectionRule object 1026 called PerSlave is created and used to connect all signals that are point to point connections between two components specific to a slave. For example each slave will have one HSEL_<slaveName>signal. The decoder component will have one HSEL_<slaveName>signal for each slave connected to the bus. This connection rule connects the slave specific ports together separately.

The following Bus signals 1022 use this rule: HSEL; HRDATA; HREADY; HRESP.

The Navigation object 1006 specifies a collection of all connection nodes associated with the current signal name and a slave name.

The connectionMethod 1028 sorts all connection nodes so that they are grouped by slave name. Each group of connections are connected together using one common connection node (usually there will only be two).

Per Master Common Connect Rule

A ConnectionRule object 1026 called PerMasterCommon is created and used to connect all signals that are connected together and have one connection to each master. For example each master will have one HRDATA_<masterName>signal. The read mux component will have one HRDATA_<busName>signal that will be connected to each master connected to the bus. This connection rule connects all of the master specific ports to one Bus specific port using one connection node.

The following BusSignal objects 1022 use this rule: HRDATA; HREADY; HRESP.

The Navigation object 1006 specifies a collection of all connection nodes associated with the current signal name and a slave name or a bus name

The connectionMethod 1028 removes all but one connection node and connects all the connections in the collection to the same node.

Per Slave Common Connect Rule

A ConnectionRule object 1028 called PerSlaveCommon is created and connected together and have one connection to each slave. For example each slave will have one HADDR_<slaveName>signal. The arbiter component will have one HADDR_<busName>signal that will be connected to each slave connected to the bus. This connection rule connects all of the slave specific ports to one Bus specific port using one connection node.

The following BusSignal objects 1022 use this rule: HADDR; HREADY; HTRANS; HWRITE; HSIZE; HBURST; HPROT; HWDATA; HMASTLOCK.

The Navigation object 1006 specifies a collection of all connection nodes associated with the current signal name and a slave name or the bus name.

The connectionMethod 1028 removes all but one connection node and connects all the connections in the collection to the same node.

It will be appreciated that the example given above is just one implementation of the invention given in order to provide an example of the invention and the manner in which it is implemented and operates, and that other databases and standards can make use of the features of the invention.

Terminology Guide

| | |
|---|---|
| Design Database | The database prior to expansion containing a |
| | specification of the bus connections between |
| | IP Blocks. |
| | A file, held electronically, e.g. in XML format, |
| | that contains the database records. The |
| | Design Database contains, in addition, a |
| | reference to the Schema File, which fully |
| | describes the types of Record that the |
| | Design Database contains. |
| Schema | A plan for a database describing the data it |
| | may Contain, their types, formats, |
| | representation and relationships. |
| | Obtained by performing an object-orientated |
| | analysis (OOA) on the data to be captured. |
| | The principal result of the OOA is a design |
| | comprising Objects, their Attributes, and |
| | their Relationships. The Schema is derived |
| | by mapping Object to Table, Attribute to |
| | Field, and Relationship to Reference Field. |
| Schema File | A file, held electronically, e.g. in XML format, |
| | that captures a particular database Schema. |
| | This is described in more detail in |
| | International Patent Application No. |
| | PCT/GB2004/001086 |
| | The Database Expander uses a Schema File. |
| | [Schema Files are themselves databases: |
| | they contain structured data whose records |
| | describe a Schema] |
| Implementation | The implementation schema of a database |
| Schema | used to hold all of the information necessary |
| | to infer and generate all components and |
| | connections required to implement the |
| | connections specified by a bus node objects |
| | in a design database. |
| Implementation Rules | The database file containing the information |
| Database (IRD) | on how to generate components and |
| | connections that implement a specific bus |
| | fabric. |
| | A file, held electronically, e.g. in XML format, |
| | that captures a particular set of |
| | Implementation rules. |
| Database Expander | The application that uses an Implementation |
| | Rules Database to automatically generate |
| | components and connections that implement |
| | the bus connections specified in a design |
| | database. |
| Expanded Database | The design database produced by the |
| | database expander containing all of the |
| | generated components and connections that |
| | implement the bus connections specified in |
| | the original design database. |

1. A method for automatically populating a database, comprising:
creating an initial database comprising a first dataset;
creating a rules database for operating on the first dataset to define new related data; and
using the rules database to generate new related data so as to create an expanded database comprising a second dataset derived from the first dataset and the generated new data.

2. A method as claimed in claim 1, wherein the data comprise electronic design data for semiconductor systems.

3. A method as claimed in claim 2, wherein the step of creating an initial database comprises entering electronic design data into a relational database.

4. A method as claimed in claim 3, wherein the step of creating a rules database comprises creating a database of rules relating initial elements of electronic design for a given system.

5. A method as claimed in claim 4, wherein the rules specify further design elements required to relate the initial design elements in a completed system.

6. A method as claimed in claim 5, comprising creating an abstract definition of parts of the system and using the abstract definition and the rules to specify the further design elements.

7. A method as claimed in claim 2, wherein the data relate to the interconnections between communication ports in different IP blocks of a system-on-chip electronic design.

8. A method as claimed in claim 2, comprising:
implementing the initial database by configuring an architecture by reading a schema file, and populating the architecture by reading a design database;
generating the rules database architecture from a representation of the design database schema; and
using the rules database to generate object classes, individual objects and object characteristics as new data.

9. A computer software product for creating automatically populated databases, comprising:
an initial database for storing a first dataset;
a rules database for storing rules for operating on the first dataset to define new related data; and
an expander that uses the rules from the rules database to generate new related data and to create an expanded database derived from the first dataset and the generated new related data.

10. A computer software product as claimed in claim 9, wherein the first dataset, rules and expanded dataset all comprise electronic design data for semiconductor systems.

11. A computer software product as claimed in claim 10, wherein the initial database comprises a relational database.

12. A computer software product as claimed in claim 11, wherein the rules database comprises a database of rules relating initial elements of electronic design data for a given system.

13. A computer software product as claimed in claim 12, wherein the rules specify further design elements required to relate the initial design elements in a completed system.

14. A computer software product as claimed in claim 13, which uses an abstract definition of parts of the system together with the rules to specify the further design elements.

15. A computer software product as claimed in claim 10, wherein the data relate to the interconnections between communication ports on different IP blocks of a system on chip electronic design.

16. A computer software product as claimed in claim 9, wherein the initial database comprises an architecture configured by reading a schema file and populated by reading a design database; and the rules database comprises an architecture generated from a representation of the design database schema.
